(19) United States
(12) Patent Application Publication
(10) Pub. No.: US 2011/0286362 A1
(43) Pub. Date: Nov. 24, 2011

(54) SCHEDULING METHODS, APPARATUSES, AND SYSTEMS

(76) Inventors: Girish Hulmani, Bangalore (IN); Rahuldev Rajguru, Rajkot (IN); Devang Thakkar, Ahmedabad (IN); Chirag Bodar, Amreli (IN)

(21) Appl. No.: 12/958,041

(22) Filed: Dec. 1, 2010

(30) Foreign Application Priority Data
May 19, 2010 (IN) 1398/CHE/2010

(51) Int. Cl. H04L 12/16

(52) U.S. Cl. 370/259

(57) ABSTRACT

A method for scheduling functions at an electronic device is provided. The method includes generating time-based information based on a selection of one or more date instances from a date page and one or more time instances from a time page. The method further includes receiving function information based on selection of at least one function from a plurality of functions. Furthermore, the method includes linking the function information to the time-based information to schedule at least one function based on the time-based information. Thereafter, the method includes enabling the electronic device to perform at least one scheduled function.

### BACKGROUND

1. Technical Field

The present invention is directed generally to methods, apparatuses, and systems for scheduling functions in electronic devices.

2. Background

Advancements in technology have resulted in the integration of numerous applications and features within electronic devices. Electronic devices such as mobile phones, personal digital assistants (PDA), and personal computers are commonly utilized for performing functions such as the exchange of Short Messaging Services (SMS), emails, voice and/or video-based calls, and the scheduling of various types of reminders and alarms.

In part due to their busy schedules, users of electronic devices are often required to use their electronic devices to perform a number of such functions at various dates and times. Often busy users forget to have one or more of important functions, such as placing a phone call or sending an email message, performed at the intended date and time. For example, a user of an electronic device may wish to make a call to a particular contact number at a particular date and time. Without access to a convenient scheduling mechanism with which to schedule the call, the user may forget to make the call at the correct time. Moreover, the chance that a user will fail to make a particular call at a particular date and time increases as the user is required to use additional functions provided by their device, such as sending SMS messages or Email messages, to communicate with multiple people on different dates and times.

Scheduling mechanisms that are currently available to users of electronic devices are cumbersome to use, and do not allow users to quickly and conveniently schedule a multitude of functions. Accordingly, there is an unfulfilled need for mechanisms that provide for the efficient and convenient scheduling of one or more functions provided by electronic devices.

### SUMMARY

In view of the foregoing, an embodiment of the invention provides a method performed at an electronic device. The method includes generating time-based information based on the selection of one or more date instances from a date page and one or more time instances from a time page. The method further includes receiving function information based on the selection of at least one function from a plurality of functions, linking the received function information to the time-based information in order to schedule at least one function based on the time-based information, and enabling the electronic device to perform at least one scheduled function.

According to some embodiments, the method further includes displaying a confirmation prompt to the user of the electronic device. In such embodiments, a scheduled function may be performed if the user provides input confirming that the scheduled function may be performed. According to other embodiments, the method further includes enabling the electronic device to perform a scheduled function after a predetermined interval period, based upon input received from a user. The method may also include enabling the electronic device to stop performing a scheduled function based upon input received from a user.

In many embodiments, the selected function may be composing, sending and/or receiving a Short Message Service (SMS) and an Electronic Mail message; a reminder function; a voice recording function; and a call management function. The method may also include receiving further input for scheduling a function in a repeating time pattern, and enabling the electronic device to perform a scheduled function in the repeating time pattern. In various embodiments, the method may further include providing a reminder to an external electronic device, the reminder being associated with a scheduled function that is to be performed by the electronic device.

Another embodiment of the invention provides an apparatus comprising one or more processors, and one or more memories comprising computer program code. The computer program code is configured to: cause the apparatus to generate time-based information based on the selection of a date instance from a date page and a time instance from a time page; receive function information based on the selection of at least one function from a plurality of functions; link the function information to the time-based information to schedule at least one function based on the time-based information; and perform at least one scheduled function.

According to some embodiments, the apparatus also displays aconfirmation prompt to a user. In such embodiments, a scheduled function may be performed if the user provides input confirming that the scheduled function may be performed. In many embodiments, the scheduled function may be: composing, sending and/or receiving a Short Message Service (SMS) message and an Electronic Mail message; a reminder function; a voice recording function; and a call management function. According to other embodiments, the apparatus further performs a scheduled function after a predetermined interval period based upon input received from a user. The apparatus may also stop performing a scheduled function based upon input received from the user. In various embodiments, the apparatus may also receive further input for scheduling a function in a repeating time pattern, and perform a scheduled function in the repeating time pattern. The scheduled function may, in various embodiments, be providing a reminder to an external electronic device.

Another embodiment of the invention provides a system for scheduling at least one function, the system comprising a time based information generator for generating time-based information based on the selection of a date instance from a date page and a time instance from a time page; a function information receiver for receiving function information based on the selection of at least one function from a plurality of functions; a linker for linking the function information to the time-based information to schedule at least one function based on the time-based information; and a scheduled function performer for performing at least one scheduled function.

According to some embodiments, the system also comprises an interface for displaying a confirmation prompt to a user. In such embodiments, a scheduled function may be performed if the user provides input confirming that the scheduled function may be performed. According to other embodiments, the system further performs a scheduled function after a predetermined interval period based upon input received from a user. The system may also stop performing a scheduled function based upon input received from the user. In various embodiments, the system further includes an input receiver for receiving a repeat input for scheduling a function in a repeating time pattern, and a function performing for performing a scheduled function in the repeating time pattern.

### BRIEF DESCRIPTION OF THE DRAWINGS

The embodiments herein will be better understood from the following detailed description with reference to the drawings, in which:

FIG. 1 illustrates an apparatus in accordance with some embodiments of the invention;

FIG. 2 illustrates a scheduling apparatus in accordance with some embodiments of the invention;

FIGS. 3A, 3B and 3C illustrate user interface views of the apparatus of FIG. 2, for function scheduling, in accordance with some embodiments of the invention; and

FIG. 4 is a flow diagram illustrating a method for scheduling functions, in accordance with some embodiments of the invention.

### DETAILED DESCRIPTION OF PREFERRED EMBODIMENTS

Features and details of the various embodiments of the invention described below are explained more fully with reference to the non-limiting illustrations in the accompanying drawings. Descriptions of well-known components and processing techniques are omitted so as to avoid unnecessarily obscuring the embodiments themselves. The examples presented herein are intended merely to facilitate an understanding of the various ways in which the invention may be practiced. The examples should accordingly not be construed as limiting the scope of the invention.

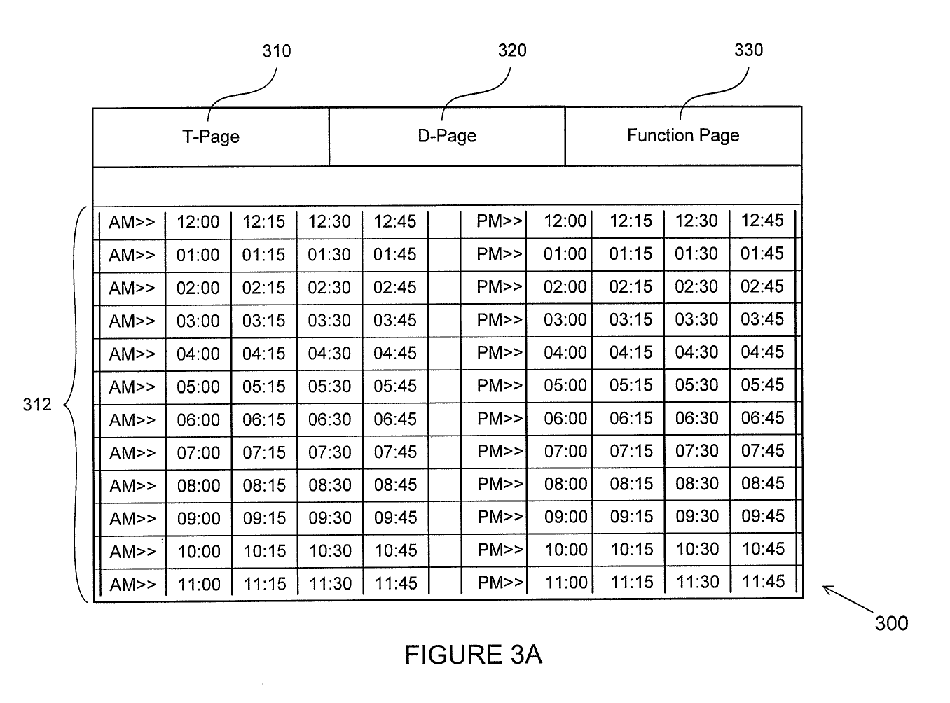

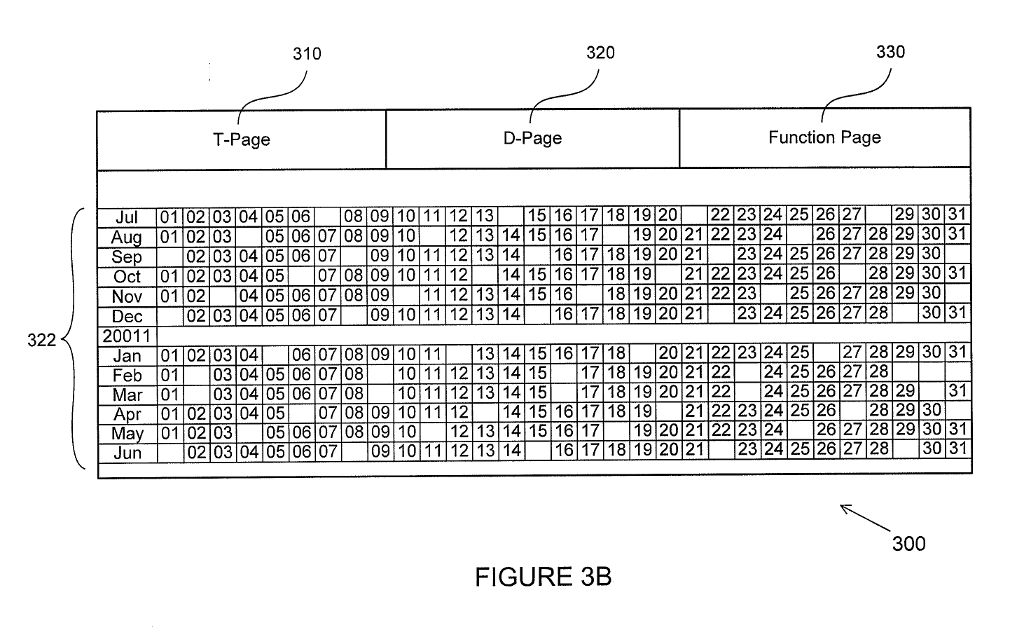

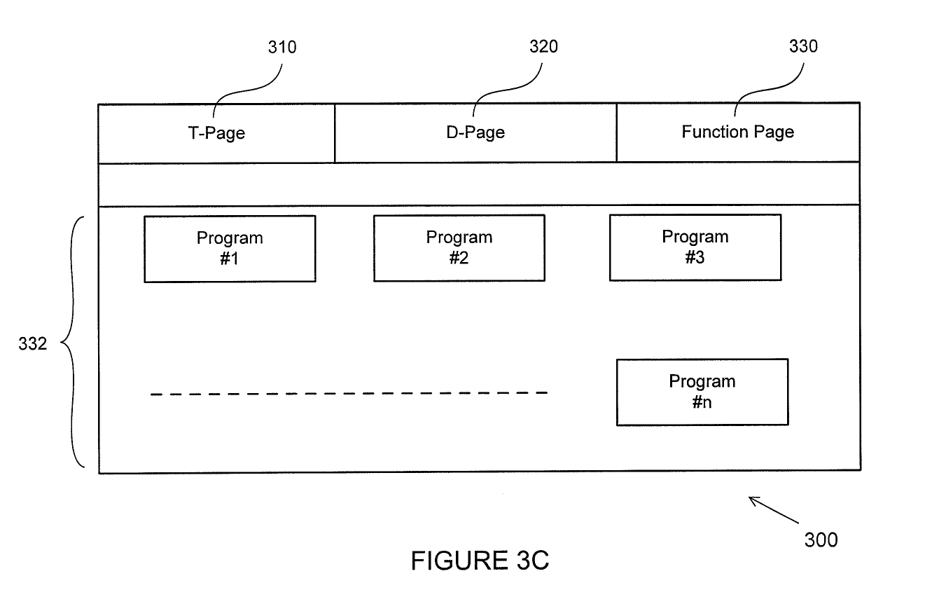

There remains a need for mechanisms that provide for the user-friendly and convenient scheduling of one or more functions provided by electronic devices. Toward that end, some embodiments described herein provide methods, apparatuses, and systems for scheduling functions such as reminders, voice calls, SMS and Email messages that are to be performed by electronic devices. In the figures referred to below, and particularly in FIGS. 3A-3C, similar reference characters denote corresponding features for the sake of clarity and consistency.

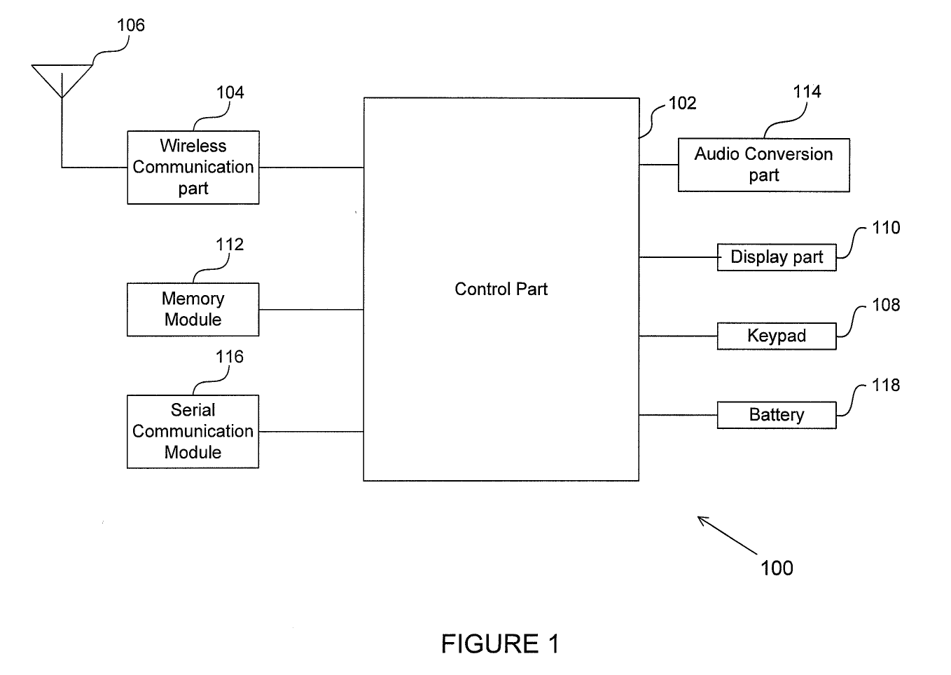

FIG. 1 illustrates an apparatus 100 in accordance with some embodiments of the invention. As such, it should be appreciated that at least some of the components described below in connection with apparatus 100 may be optional. Accordingly, various embodiments may include more, fewer or different components than those described in connection with FIG. 1. Apparatus 100 may be any of a number of types of electronic devices with or without telephony capabilities, for example, personal digital assistants (PDAs), pagers, mobile televisions, gaming devices, cellular phones, all types of computers (e.g. laptops, notebooks, mobile computers, tablet personal computers and desktop computers), cameras, audio/video players, radios, global positioning system (GPS) devices, media players, mobile digital assistants, or any combination of the aforementioned devices, and other types of communications devices. As illustrated in FIG. 1, apparatus 100 may comprise a control part 102, a wireless communication part 104, an antenna 106, a keypad 108, a display part 110, a memory module 112, an audio conversion part 114, a serial communication module 116, and a battery 118.

The control part 102 of apparatus 100 may be responsible for generally controlling apparatus 100, and may include one or more processors. The control part 102 may organize the overall operation of programming and/or scheduling functions within apparatus 100 by linking functions to date and time commands. The control part 102 may include circuitry implementing, among other functions, audio and logic functions of apparatus 100. For example, the control part 102 may include one or more digital signal processor devices, one or more microprocessor devices, one or more processors with accompanying digital signal processors, one or more processors without accompanying digital signal processors, one or more special-purpose computer chips, one or more field-programmable gate arrays (FPGAs), one or more controllers, one or more application-specific integrated circuits (ASICs), one or more computers, various analog to digital converters, digital to analog converters, and/or other support circuits. Control and signal processing functions of apparatus 100 are allocated between these devices according to their respective capabilities. The control part 102 may also include functionality to operate one or more software programs that may be stored in a memory. The control part 102 may also be embodied as a multi-core processor such as a dual or quad core processor.

The wireless communication part 104 of apparatus 100 may be in communication with one or more antennas, such as antenna 106. The wireless communication part 104 may include a transmitter and a receiver, or a transceiver. The control part 102 of apparatus 100, or another processing device, may provide signals to, and/or receives signals from, the wireless communication part 104. The signals may include signalling information in accordance with the air interface standard of the applicable cellular system, and/or may also include data corresponding to user speech, received data and/or user generated data. Apparatus 100 may be capable of operating in accordance with any of a number of first, second, third and/or fourth-generation communication protocols. For example, apparatus 100 may be capable of operating in accordance with wireless communication protocols such as GSM (global system for mobile communication) IS-95 (code division multiple access (CDMA)), Universal Mobile Telecommunications System (UMTS), CDMA1000, wideband CDMA (WCDMA) and time division-synchronous CDMA (TD-SCDMA), evolved-universal terrestrial radio access network (E-UTRAN), or with fourth-generation (4G) wireless communication protocols. Additionally, or alternatively, apparatus 100 may be capable of operating in accordance with non-cellular communication mechanisms. For example, apparatus 100 may be capable of operating in accordance with computer networks such as the Internet, local area networks, wide area networks; short range wireless communication networks such as include Bluetooth® networks, Zigbee® networks, Institute of Electric and Electronic Engineers (IEEE) 802.11x networks; and wireline telecommunication networks such as public switched telephone networks (PSTN).

The keypad 108 of apparatus 100 may be an interface between apparatus 100 and its user. The keypad 108 is input means for a user and is configured to transmit the user's selection to apparatus 100. The keypad 108 may include buttons such as function buttons for communicating specific functions, and general buttons for communicating letters and figures. In embodiments including the keypad 108, the keypad 108 may include numeric (e.g. 0-9) and related keys (e.g. # and *), and other hard and soft keys used for operating apparatus 100. For example, the keypad 108 may be a generic keypad or input device that includes keys indicating characters, numbers, and keys specific to functions such as multimedia functions, shortcuts, power on/off, volume control, and the like. Alternatively, the keypad 108 may include a conventional QWERTY keypad arrangement. The keypad 108 may also include various soft keys with associated functions. In addition, or alternatively, apparatus 100 may include one or more interface devices such as joysticks or other user interface devices.

The display part 110 of apparatus 100 provides a screen for displaying various information and options to the user, thereby enabling the user to access or provide information for scheduling functions. The display part 110 may display a menu with options allowing a user to select information, and/or other information provided by the user.

The memory module 112 of apparatus 100 may store programs and/or data for performing various functions. The stored programs and/or data may be processed by the control part 102 of apparatus 100. For example, the memory module 112 may store programs and/or data associated with algorithms for implementing one or more functions. The memory module 112 may be one or more of a variety of volatile and/or non-volatile memories. Apparatus 100 may also include mass storage devices (not shown) similar to those associated with other general-purpose computer systems. Program code comprising one or more program modules may be stored in the memory module 112. Such program modules may include, for example, an operating system, one or more application programs, other program modules, and program data.

The audio conversion part 114 of apparatus 100 performs the conversion of a user's voice signal recorded through a microphone, using for example, a signal processing method such as digital signal processing (DSP). The audio conversion part 114 may also perform a conversion of a signal received from another user and may output an analog voice signal through a speaker after processing the received signal data. The apparatus 100 may also comprise a user interface, coupled to the control part 102, that includes output devices such as ringers, earphones, speakers, and user input devices such as a microphones.

Serial communication module 116 may transmit and/or receive data while connected to an apparatus such as a notebook computer or a PC, via a serial cable or other connection device and/or mechanism that supports serial communication. Further, apparatus 100 may additionally and/or alternatively include communication parts for performing data transmission or reception associated with, for example, Wi-Fi, Bluetooth® networks, Zigbee® networks, Institute of Electric and Electronic Engineers (IEEE) 802.11x networks. Apparatus 100 may further include a battery 118, such as a vibrating battery pack, for powering one or more circuits used to facilitate the operation of apparatus 100. Apparatus 100 may also provide mechanical vibration as detectable output.

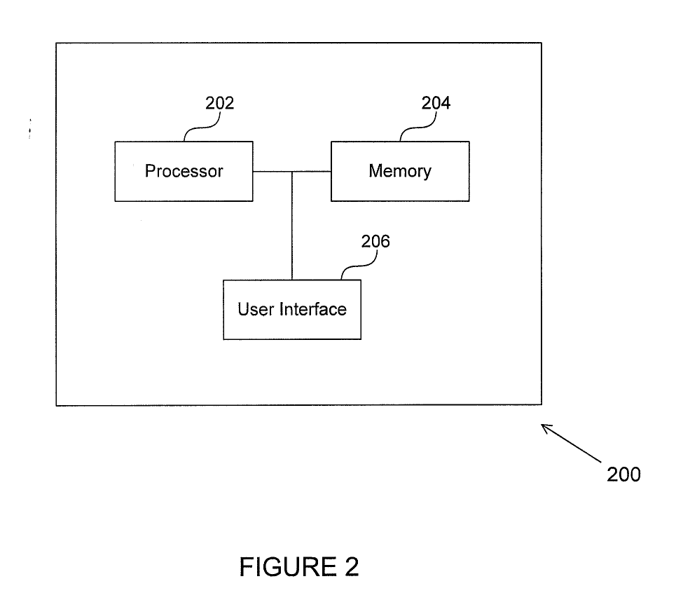

FIG. 2 illustrates a scheduling apparatus 200 in accordance with some embodiments of the invention. Apparatus 200 may be employed, for example, in apparatus 100 of FIG. 1. However, apparatus 200 may also be employed on a variety of other devices both mobile and fixed. Examples of apparatus 200 include mobile phones, personal digital assistants (PDAs), cellular phones, all types of computers (for example, laptops, mobile computers or desktop computers), cameras, audio/video players, radios, and global positioning system (GPS) devices. Alternatively or additionally, embodiments of apparatus 200 may be employed on a combination of devices including, for example, those listed above. Accordingly, various embodiments of apparatus 200 may, for example, be embodied wholly at a single device, such as the device 100, or in a combination of devices. Furthermore, one or more elements described below may be optional and therefore omitted.

According to some embodiments, apparatus 200 may schedule one or more functions on a variety of dates and times. Apparatus 200 may also include or otherwise access at least one processor 202 and at least one memory 204. Memory 204 may be, for example, a random access memory, a dynamic random access memory, a static random access memory, a hard disk, a magnetic tape, an optical disk, a programmable read only memory, an erasable programmable read only memory, an electrically erasable programmable read only memory, and a flash memory. The memory 204 may be configured to store, for example, information, data, applications, and instructions for enabling apparatus 200 to carry out a variety of functions, in accordance with the invention.

The processor 202 may, in some embodiments, be the control part 102 of FIG. 1. In many embodiments, processor 202 may be and/or include general purpose microprocessors, microcontrollers, application specific processors such as application specific integrated circuits (ASICs), modulator-demodulators (MODEMs), central processing units, digital signal processors (DSPs), field programmable gate arrays (FPGAs), any suitable specific or general-purpose processors, and any device that can process data from a memory. The processor 202 may be configured by hardware or software methods, or by a combination thereof. Moreover, the processor 202 may be an entity that is capable of performing various operations and is, for example, physically embodied in circuitry. For example, when processor 202 is composed of two or more of an ASIC and a FPGA, the processor 202 may be specifically configured hardware for conducting the operations that are performed by ASICs and FPGAs. Moreover, when the processor 202 is an executor of software instructions, the instructions may specifically configure the processor 202 to perform algorithms and/or operations specified by the instructions.

Apparatus 200 may also include a user interface 206, in communication with the processor 202. Examples of the user interface 206 include but are not limited to, input user interfaces and/or output user interfaces. An input user interface is configured to receive input from a user, and an output user interface is configured to provide output to a user. Apparatus 200 may also include one or more sets of input mechanisms corresponding to hardware components that enable the user to enter input when interacting with user interface features of apparatus 200. Examples of input mechanisms include a contact-sensitive display, a mouse, a joystick, a scroll-wheel, a keypad, a button, a dial, a multi-dimensional input device, and a microphone. An output user interface provides an audible, visual, mechanical or other output and/or feedback to the user. Examples of an output interface includes a display such as light emitting diode display, a thin-film transistor (TFT) display, a liquid crystal display, an active-matrix organic light-emitting diode (AMOLED) display; a microphone; a speaker; a ringer; and a vibrator. According to some embodiments, the processor 202 may comprise user interface circuitry configured to control at least some functions of one or more elements of the user interface 206 (e.g. a speaker, ringer, microphone, and/or a display). The processor 202 and/or user interface circuitry comprising the processor 202 may be configured to control one or more functions of one or more elements of the user interface 206 through computer program instructions (e.g. software and/or firmware) that are stored on a memory (e.g. memory 204), and accessible to the processor 202.

A user may operate the user interface 206 in order to select an entry from a list provided by the user interface 206. For example, the user may select a particular date from a plurality of dates displayed on the user interface 206. Similarly, the user may select a particular time from a plurality of times, and a function from a plurality of functions displayed on the user interface 206. In some embodiments, the user interface 206 may provide a window or a display area where various time instances, date instances, and a plurality of functions may be displayed for selection by a user. Further, multiple communication identifiers (e.g. e-mail, mobile number, SMS, and MMS) may also be displayed for selection. The processor 202 may also generate the window on a display device dynamically, in response, for example, to a user's selection of a particular date, time and/or function.

According to many embodiments, the processor 202 may be configured, using the memory 204, and optionally other components described herein, to cause apparatus 200 to schedule functions at one or more particular dates and times. For example, the processor 202, operating under software control, and/or embodied as an ASIC or FPGA and specifically configured to perform the operations of an ASIC or FPGA, may configure apparatus 200 or other circuitry to schedule functions in the apparatus 200 at various specific dates and times. Function scheduling is described further in conjunction with FIGS. 3A, 3B and 3C below.

FIGS. 3A, 3B and 3C illustrate representations of a user interface 300, used for scheduling date and/or time-based functions associated with apparatus 200, in accordance with the invention. User interface 300 depicts a time page (T-Page) 310, a date page (D-page) 320, and a function page 330, utilized for scheduling functions associated with apparatus 200. User interface 206, described in conjunction with FIG. 2, may also provide the features and functionality of user interface 300.

According to various embodiments, if a user clicks on the T-page 310, a time window 312 associated with the T-page 310 is displayed. The time window 312 may include a plurality of time instances in Ante Meridian (AM) and Post Meridian (PM) format. In the illustrated embodiment, a plurality of time instances are depicted. In this embodiment, consecutive time instances depicted are 15 minutes apart, however many other embodiments may depict a plurality of time instances separated by smaller or larger time intervals. It will be apparent to those ordinarily skilled in the art that selectable time instances of any granularity can be incorporated in the T-page 310. Further, in some embodiments, the time window 312 may include time instances in a 24 hour format, where successive time instances differ based on a particular hour or minute-based time interval. In various embodiments, a user may select a particular time instance from the time instances depicted, in order to schedule a function.

According to many embodiments, if a user clicks on the D-page 320, a date window 322 associated with the D-page 320 is displayed. The date window 322 may include dates of a year in a month-oriented pattern, as depicted in FIG. 3B. Additionally, rows of the date window 322 may scroll up every month, with the first row depicting the current month. For example, in the month of July, 2010, the first row of the date window 322 displays the month of July. In some embodiments, similar days in the date window 322 may be displayed employing a VIBGYOR color scheme to aid in their identification.

After a user has selected a date instance and a time instance, the processor 202 is configured, using memory 204, and optionally using other components described herein, to cause apparatus 200 to generate time-based information. The time-based information includes information of the selected time and date. Further, the processor 202 may be configured, using memory 204, to receive function information from the function page 330. In some embodiments, if the user clicks on the function page 330, a function window 332 is displayed. As depicted in FIG. 3C, the function window 332 displays a plurality of functions (e.g. program 1, program 2, program 3 and program n). The plurality of functions may include, without being limited to, a Short Message Service (SMS) function, an email function, a reminder function, a voice record function, a call management function, and a profile management function. These functions are described in further detail below.

According to some embodiments, user interface 300 may also provide the user with the ability to select a ‘done’ option. The ‘done’ option may be selected by the user once the user completes the selection of one or more time instances from the T-page 310, one or more date instances from the D-page 320, and at least one function from the function page 330. The processor 202 may further be configured, using the memory 204, to link the function information and the time-based information, in order to schedule the at least one function.

Furthermore, the processor 202, along with the memory 204, may be configured to enable apparatus 200 to perform at least one scheduled function. For example, if the user selects a time of 4:30 PM from the time window 312, and a date of Jul. 30, 2010 from the date window 322, time-based information associated with the time of 4:30 PM from the time window 312, and the date of Jul. 30, 2010 from the date window 322, is generated. Further, if the user selects the Program 2 (e.g., ‘make a call’ function) from the function page 332, the time-based information and the call function are linked for scheduling the call function. In some embodiments, if the user selects the ‘make a call’ function, the processor 202 causes the apparatus 200 to display a list of contact numbers, from which the user may select one or more desired contact numbers. Thereafter, the processor 202, along with the memory 204 may be configured to cause apparatus 200 to place one or more calls to one or more desired contact numbers at the scheduled dates and times.

User interface 300 depicted in FIGS. 3A, 3B and 3C are exemplary embodiments only, and should not be construed as limiting. According to various embodiments, the time window 312, the date window 322, and the function window 332 may be displayed simultaneously in user interface 300. Alternatively, the time window 312 and the date window 322 may be displayed together, as one page of the user interface 300, and the function window 332 may be displayed in a separate page of user interface 300.

In various embodiments, user interface 300 may be a user interface that is similar to user interface 206, but external to apparatus 200. In such embodiments, the time-based information, which includes information on the selection of the date and time instances, and/or the function information, may be received from an external interface. The processor 202 may also be capable of communicating with the external interface in order to receive the function information and the time-based information. Examples of an external interface include, but are not limited to, PC/web interfaces, calendar/task Plug-ins, and other data streams accessible to the processor 202. In some embodiments, the external interface may include a T-page, a D-page and a function page, similar to the T-page 310, the D-page 320 and the function page 330.

In various other embodiments, the processor 202, along with the memory 204, causes apparatus 200 to provide options for scheduling at least one function in a repeating time pattern. In one embodiment, user interface 300 may display an option where user input indicating the repeatability of any function (for example ‘a repeat input’) may be received. For example, a user may provide input for performing a function on an hourly basis, a monthly basis, a weekly basis, or a yearly basis. Based on such user input, the processor 202 may be configured to cause apparatus 200 to perform at least one scheduled function in a repeating time pattern.

In some embodiments, the processor 202, along with the memory 204, may cause apparatus 200 to provide a user with options for indicating a ‘snooze’ input, while scheduling a function. For example, if processor 202 receives an input indicating the need to execute a ‘snooze’ operation, apparatus 200 may re-perform the scheduled function at a predetermined periodic interval after the function is performed at the scheduled time. In some embodiments, apparatus 200 may also provide an option for the user to indicate that he/she would like to deactivate a ‘snooze’ operation. For example, if apparatus 200 receives input from the user indicating the user's wish to deactivate a ‘snooze’ operation, apparatus 200 may stop performing the scheduled function at set intervals after the scheduled function's scheduled time has passed.

In some other embodiments, apparatus 200 may display a confirmation prompt in order to alert the user or gain his/her permission prior to performing a scheduled function. For example, a user may receive a reminder alert and/or may be asked to provide input indicating confirmation before a scheduled call is placed. Upon receiving appropriate confirmation from the user, a call may be placed to one or more desired contact numbers, at the scheduled time.

Hereinafter, a scheduled time refers to a time and a date selected from the time window 312 and the date window 322. For the sake of clarity, examples involving the scheduling of various functions associated with apparatus 200 are described below.

Example of Call Scheduling: To schedule a voice call, an existing function (e.g. the ‘make a call’ function) associated with a desired phone number, may be associated with a particular date and time. In an example embodiment, a user may select a date from the date window 322 and a time from the time window 312, and thereafter tap or click on the function ‘make a call’ from the function window 332, to schedule the ‘make a call’ function. Once the user taps or clicks on the function ‘make a call’, apparatus 200 may display a contact list and a contact number pad on a display of apparatus 200. The user may then select or enter one or more desired contact numbers. Thereafter, at the scheduled time (for example, at the date and time selected by the user), the processor 202, along with the memory 204, may cause apparatus 200 to place one or more calls to the one or more desired numbers. It will be apparent to those skilled in the art that multiple calls may also be scheduled by the selection of multiple times and dates from the time window 312 and the date window 322. In an example embodiment, before a scheduled call is actually placed, a dialogue box may be presented to the user, via a display of apparatus 200. The dialogue box may prompt the user in order to receive input from the user regarding whether the user wishes to proceed with or cancel the call. In another example embodiment, miscellaneous features providing the user with the ability to view, delete or modify numbers associated with scheduled calls may be integrated into apparatus 200. Similarly, apparatus 200 may also provide the user with the option of scheduling a conference call, where the user may be provided with the option of selecting and/or specifying additional contact numbers to be associated with the conference call.

Example of scheduling a voice reminder: A ‘voice reminder’ function that plays a recorded voice message may be scheduled at a particular date and time. In some embodiments, a user may pick a date from the date window 322 and a time from the time window 312, and then tap or click on the function ‘voice reminder’ from the function window 332 to schedule the ‘voice reminder’. Once the user taps or clicks on the function ‘voice reminder’, apparatus 200 may launch a voice recorder that may record the voice of the user. Thereafter, at the scheduled time (for example, at the date and time selected by the user), the processor 202, along with the memory 204, may cause apparatus 200 to play the recorded voice. In various embodiments, apparatus 200 may also be involved in performing various miscellaneous features such as verifying, appending and deleting the recorded voice.

Example of scheduling a custom audio list reminder: In some embodiments, a ‘custom audio list’ function may be used for playing user-created pre-recorded audio/voice files. After a user selects a date and a time, and then taps or clicks on the ‘custom audio list’ function, apparatus 200 may display an audio/voice menu from where a pre-recorded audio/voice file can be selected. The selected audio/voice file from the audio/voice menu may then be played at the scheduled time. In various embodiments, apparatus 200 may also be involved in performing various miscellaneous features such as verifying preset audio/voice files, adding a new audio/voice file to the audio/voice menu, setting standard alarms, and deleting an audio/voice file from the audio/voice menu.

Example of scheduling a ‘memo’ function: A ‘memo’ function enables the user to enter a text message that acts a text reminder for the user of an electronic device. After a user selects one or more dates and times, and taps or clicks a ‘memo’ function, apparatus 200 may open an editor in which text can be entered. In some embodiments, apparatus 200 may also enable the selection of predefined text messages. In various embodiments, apparatus 200 may also be involved in performing miscellaneous features such as viewing, deleting or editing an entered text message, and adding pre-defined text. In some embodiments, a sound may be played for notification purposes at the scheduled time, and/or a vibration alert may be executed at the scheduled time.

Example of scheduling an SMS message: An ‘SMS’ message function enables a user of an electronic device to compose one or more SMS messages and to schedule the transmission of the message(s) to their intended recipient(s). In many embodiments, after a user selects date(s) and time(s) for sending the SMS message, and then taps/clicks on an ‘SMS’ function, apparatus 200 launches an SMS editor in which the appropriate recipients' mobile numbers and the text associated with the SMS message may be entered. In some embodiments, predefined SMS text messages may also be selected and used. Apparatus 200 may then send the composed and/or selected SMS message to the recipients' mobile number(s) at the scheduled time(s). In various embodiments, apparatus 200 may also be involved in performing miscellaneous features such as viewing, deleting or editing SMS messages, auto-replying to an incoming SMS message, forwarding an incoming SMS message to various target recipients, and adding pre-defined messages.

Example of scheduling a voice SMS message: A ‘voice SMS’ function enables a user to compose one or more voice SMS messages and schedule the message to be sent at particular time(s) to intended recipient(s). After a user selects one or more specific dates and times, and taps/clicks on a ‘voice SMS’ function, apparatus 200 may launch a voice recorder along with a voice SMS editor in order that the user may provide and/or select the contact numbers of one or more recipients, as well as compose a voice message. The recorded voice may then be attached to the SMS message. In various embodiments, a predefined audio SMS message may be selected. The selected and/or composed voice SMS message may then be sent at the scheduled time(s) to the specified recipient(s). In various embodiments, apparatus 200 may also provide miscellaneous features such as verifying, viewing, deleting or editing the voice SMS messages and adding pre-defined voice messages.

Example of scheduling Email messages: Scheduling an ‘Email’ function enables a user to compose Email messages and schedule their transmission at particular time(s) to intended recipient(s). After a user selects one or more specific dates and times, and taps/clicks on an ‘Email’ function, apparatus 200 may launch an ‘Email editor’ in order that Email Identifiers (IDs) associated with intended recipient(s), a subject, and a message body may be entered. In some embodiments, predefined text may be selected when composing portions of an Email message. A composed Email message may then be sent to the specified recipient(s) at the scheduled time(s). In various embodiments, apparatus 200 may also provide miscellaneous features such as viewing, deleting or editing Email text, adding pre-defined messages, forwarding an incoming Email, auto-replying to specific senders, and attaching a particular file with the scheduled.

Example of scheduling a short bell alert: Scheduling a ‘short bell alert’ function enables the playing of a short bell alert at one or more scheduled time(s). After a user selects one or more dates and times, and taps/clicks on a ‘short bell alert’ function, apparatus 200 may play a bell or other sound at the scheduled time(s).

Example of scheduling a text reminder: Scheduling a ‘text reminder’ function enables the triggering of a text reminder on a second apparatus by a first apparatus. For example, the first apparatus may be apparatus 200, which may in turn be a mobile handset. The second apparatus may also be a mobile handset that utilizes the same platform as apparatus 200. If a user selects one or more dates and times, and taps/clicks on a ‘send text reminder’ function, apparatus 200 may display a text message editor and a contact list, using which phone numbers associated with the intended recipient(s) of the text reminder may be selected, and the text reminder message may be entered. Apparatus 200 may then either send an SMS message with a proprietary message in its body, or route the message through the Internet. The platform of the recipient mobile handset may then intercept/interpret the received message and alert the user of the recipient mobile handset using the received message, at the scheduled date and time set by the sender of the text reminder.

Example of scheduling an audio/video reminder: Scheduling an ‘audio/video reminder’ enables the triggering of a voice/video reminder on another apparatus different from the apparatus used to schedule the reminder. If a user selects one or more dates and times and then taps/clicks on an ‘audio/video reminder’ function, a recorder may be launched to record the sender's voice message, and/or a video capturing means in apparatus 200 may be triggered to capture a video of the sender. Further, a contact list may be launched, from which contact numbers of the recipient(s) of the audio/video reminder may be selected. An editor for entering a message may also be launched in order to receive a message. The sender's platform may thereafter either send a voice and/or a video message with a proprietary message in the body of the message to the message recipient(s), or route the voice and/or video message through the Internet. The platform on the recipient mobile handset(s) may then intercept/interpret the received message and play the voice/video at the time(s) scheduled by the sender of the message. In many embodiments, a ‘send standard alert’ function may be similarly scheduled. Such a function enables the playing of a standard message that may be predefined, pre-recorded and/or pre-captured, at electronic devices associated with recipient(s) having pre-assigned standard contact numbers.

Example of scheduling a message call: A ‘message call’ function is similar to a voice call function, one difference being that in a message call, a recorded message is played when the call is connected. A ‘message call’ function enables a user to record a message that is to be later played, and specify the contact numbers of one or more call recipients. In many embodiments, a message call may be scheduled by selecting one or more dates and times and tapping/clicking on a ‘message call’ function. These events may result in apparatus 200 launching a contact list that includes the phone numbers of potential recipient(s), and a voice recording application. After a user selects one or more recipients and/or enters one or more recipient contact numbers, and records a message to associate with the message call, apparatus 200 may, at the one or more scheduled times, place one or more calls to the phone numbers of the recipient(s), in order to play the recorded message once the call(s) are received by the recipients(s). In various embodiments, a dialog box prompting the user to indicate whether or not to proceed with a scheduled message call may be launched before a scheduled message call is placed. In many embodiments, apparatus 200 may also enable features such as viewing, deleting or modifying recorded messages and recipient numbers.

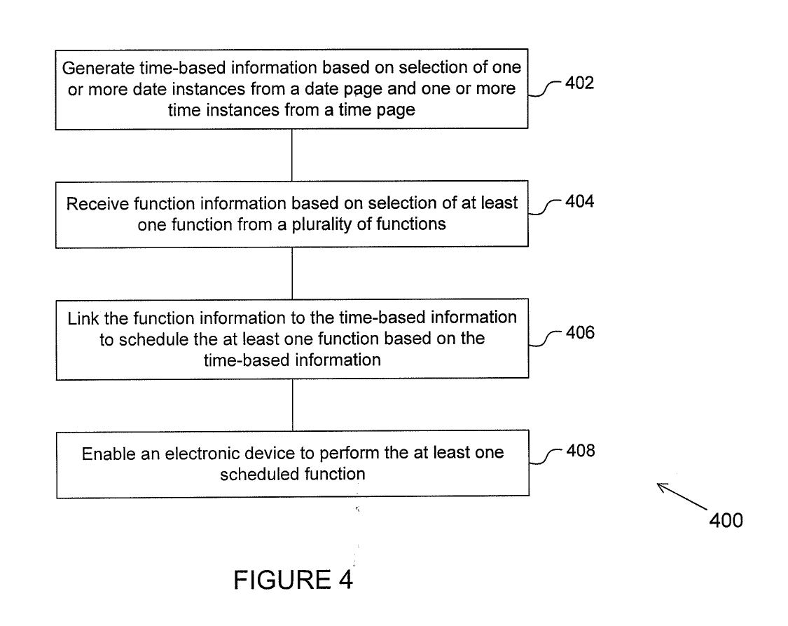

FIG. 4 depicts a flowchart that illustrates a method 400 for scheduling functions using an electronic device, according to an embodiment of the invention. Method 400 may be executed by an electronic device such as apparatus 200 of FIG. 2. In many embodiments, the electronic device may be a mobile handset. Method 400 may be implemented by various means, including hardware, firmware, processor, circuitry and/or using other device associated with execution of software including one or more computer program instructions of apparatus 200.

At step 402, time-based information is generated at an electronic device. In some embodiments, the time-based information may be generated based on the selection of one or more date instances from a date page such as the D-page 320 of FIG. 3B, and the selection of one or more time instances from a time page such as the T-page 310 of FIG. 3A. At step 404, function information may be received at the electronic device, based on the selection of at least one function from a plurality of functions provided on a function page such as the function page 330 of FIG. 3C. According to some embodiments, upon selection of a function, the electronic device may prompt the user to enter additional information related to the function. For example, if the user selects a function for placing a call, the user may be prompted to enter a desired contact number, or select one or more contact numbers from a list of contact numbers. At step 406, the generated time information and the function information are linked in order to schedule at least one function based on the time information. Thereafter, at step 408, method 400 enables the electronic device to perform the scheduled at least one function at the scheduled time.

In some embodiments, the steps depicted in FIG. 4 may not be performed in the order depicted. For example, the step 404 may be performed before the step 402. More specifically, a user may first select a function from the plurality of functions, and thereafter select a date instance and a time instance in any order. Accordingly, the function information may be received at the electronic device before the time-based information is generated from the selected date instance and the time instance.

Various embodiments include different combinations of patterns for the selection of date instances, time instances and functions. In the embodiments described below, d1, d2, d3 . . . dn represent date instances selected from the date window associated with a D-page, such as the D-page depicted by element 322 of FIG. 3B; and t1, t2, t3 . . . tm represent time instances selected from the time window associated with a T-page, such as the T-page depicted by element 312 of FIG. 3A. The embodiments below illustrate use cases for scheduling of a function with respect to various selection patterns associated with date instances and time instances.

Case 1: If the order of selection is <t1, t2, t3 . . . tn, d1, d2, d3, . . . dm, function>, at each of the date instances d1, d2, d3 . . . dm, the function is scheduled to be performed at time instances t1, t2, t3, . . . tn.

Case 2: If the order of selection is <d1, d2, d3, . . . dm, t1, t2, t3 . . . tn, Function>, at the time instances t1, t2, t3, . . . tn of each date instances d1, d2, d3, . . . dm, the function is scheduled to be performed.

Case 3: If the order of selection is <d1, t1, t2, t3, d2, t1, t4, t5, d3, t6, t7, t8, . . . dm, t1, t2, t3 . . . tn, function>, then for date instance d1, at times instances t1, t2, t3; for date instance d2, at times instances t1, t4, t5; for date instance d3, at times instances t6, t7, t8, . . . ; and for date instance dm, at times instances t1, t2, t3, the function is scheduled to be performed.

Case 4: If the order of selection is <t1, d1, d2, d3, t2, d1, d4, d5, t3, d6, d7, d8, . . . , tm, d1, d2, d3 . . . dn, function>, then at time instance t1 on date instance d1, d2, d3; at time instance t2 on date instances d1, d4, d5; at time instance t3 on date instances d6, d7, d8, . . . ; and at time instance tm on date instances d1, d2, d3, . . . , dn; the function is scheduled to be performed.

The present invention may take the form of a computer program product for computing electrical characteristics of interconnect lines, on a computer-readable storage medium having computer-readable program instructions (e.g., computer software) embodied in the computer-readable storage medium. Any suitable computer-readable storage medium (hereinafter ‘storage medium’) may be utilized including hard disks, CD-ROMs, RAMs, ROMs, Flash memories, optical storage devices, or magnetic storage devices.

The present invention is described above with reference to block diagrams and flowchart illustrations of methods and apparatuses embodying the present invention. It will be understood that various blocks of the block diagrams and flowchart illustrations, and combinations of blocks in the block diagrams and flowchart illustrations, respectively, may be implemented by a set of computer program instructions, in any order. These sets of instructions may be loaded onto a general purpose computer, special purpose computer, or other programmable data processing apparatus to cause a device, such that the set of instructions when executed on the computer or other programmable data processing apparatus creates a means for implementing the functions specified in the flowchart block or blocks. Other means for implementing the functions including various combinations of hardware, firmware and software as described herein may also be employed.

These computer program instructions may also be stored in a computer-readable medium that can cause a computer or other programmable data processing apparatus to function in a particular manner, such that the instructions stored in the computer-readable memory produce an article of manufacture including computer-readable instructions for implementing the function specified in the flowchart of the method 400. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart of the method 400.

Without in any way limiting the scope, interpretation, or application of the claims appearing below, a technical effect of one or more of the example embodiments disclosed herein is to provide an easy and convenient way to schedule/program various functions on particular date(s) and time (s). Since access to the date page, time page is readily available for the user, the user can easily select/pick one or more date instances from the date window of the date page, and one or more time instances from time window associated with the time page. Similarly, the user can easily select/pick at least one function from a plurality of functions. The apparatus of the present invention is capable of scheduling multiple features at multiple dates and times.

Various embodiments described above may be implemented in software, hardware, application logic or a combination of software, hardware and application logic. The software, application logic and/or hardware may reside on at least one memory, at least one processor, an apparatus or, a computer program product. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of an apparatus described and depicted in FIGS. 1 and/or 2. A computer-readable medium may comprise a computer-readable storage medium that may be any media or means that can contain or store the instructions for use by or in connection with an instruction execution system, apparatus, or device, such as a computer.

The foregoing descriptions of specific embodiments of the present disclosure have been presented for purposes of illustration and description. They are not intended to be exhaustive or to limit the present disclosure to the precise forms disclosed, and various modifications and variations are possible in light of the above teaching. It is understood that various omissions and substitutions of equivalents are contemplated as circumstance may suggest or render expedient, but such are intended to cover the application or implementation without departing from the spirit or scope of the claims of the present disclosure.

I/We claim:

1. A method performed at an electronic device comprising a processor, a memory, and a display, the method comprising:
generating time-based information based on a selection of at least one date instance from a date page and a selection of at least one time instance from a time page;
receiving function information based on a selection of at least one function from a plurality of functions;
linking the function information to the time-based information to schedule at least one function based on the time-based information; and
enabling the electronic device to perform at least one scheduled function.

2. The method of claim 1, further comprising displaying a confirmation prompt, wherein at least one scheduled function is performed if a confirmation input for performing the scheduled at least one function is received from a user at the confirmation prompt.

3. The method of claim 1, wherein the at least one function comprises a Short Message Service (SMS) function, an email function, a reminder function, a voice record function and a call management function.

4. The method of claim 1, further comprising enabling the electronic device to re-perform at least one scheduled function in a predetermined periodic interval upon performing at least one schedule function, wherein the re-performance is based on receiving snooze input.

5. The method of claim 4, wherein the re-performing of at least one function in the predetermined periodic function is stopped based on receiving a snooze-off input.

6. The method of claim 1, further comprising:
receiving a repeat input for scheduling at least one function in a repeating time pattern; and
enabling the electronic device to perform at least one scheduled function in the repeating time pattern.

7. The method of claim 1, further comprising providing a reminder to an external electronic device, the reminder associated with at least one scheduled function.

8. An apparatus comprising:
at least one processor; and
at least one memory comprising computer program code, the at least one memory and the computer program code configured, with the at least one processor, to cause the apparatus to at least:
generate time-based information based on a selection of at least one date instance from a date page and a selection of at least one time instance from a time page;
receive function information based on a selection of at least one function from a plurality of functions;
link the function information to the time-based information to schedule at least one function based on the time-based information; and
perform at least one scheduled function.

9. The apparatus of claim 8, further displaying a confirmation prompt, wherein at least one scheduled function is performed if a confirmation input for performing at least one scheduled function is received from a user at the confirmation prompt.

10. The apparatus of claim 8, wherein the at least one function comprises a Short Message Service (SMS) function, an email function, a reminder function, a voice record function and a call management function.

11. The apparatus of claim 8, wherein the processor, upon receipt of a snooze input, is further configured to cause the apparatus to perform at least one function in a predetermined periodic interval upon performing at least one scheduled function.

12. The apparatus of claim 11, wherein the processor, upon receipt of a snooze off input, is further configured to cause the apparatus to stop performing the at least one function in the predetermined periodic function.

13. The apparatus of claim 8, wherein the processor is further configured to cause the apparatus to:
receive a repeat input for scheduling at least one function in a repeating time pattern; and
perform at least one scheduled function in the repeating time pattern.

14. The apparatus of claim 8, wherein the at least one function is providing a reminder to an external electronic device.

15. A system for scheduling at least one function, the system comprising:
a time-based information generator for generating time-based information based on a selection of at least one date instance from a date page and a selection of at least one time instance from a time page;
a function information receiver for receiving function information based on a selection of at least one function from a plurality of functions;
a linker for linking the function information to the time-based information to schedule at least one function based on the time-based information; and
a scheduled function performer for performing the scheduled at least one function.

16. The system of claim 15, further comprising an interface for displaying a confirmation prompt, wherein at least one scheduled function is performed if a confirmation input for performing at least one scheduled function is received from a user at the confirmation prompt.

17. The system of claim 15, wherein the at least one function comprises a Short Message Service (SMS) function, an email function, a reminder function, a voice record function and a call management function.

18. The system of claim 15, wherein upon receipt of a snooze input, the system performs at least one function in a predetermined periodic interval upon performing at least one scheduled function.

19. The system of claim 15, wherein upon receipt of a snooze off input, the system is further configured to stop performing the at least one function in the predetermined periodic function.

20. The system of claim 15, further comprising:
an input receiver for receiving a repeat input for scheduling at least one function in a repeating time pattern; and
a function performer for performing at least one scheduled function in the repeating time pattern.
